(19) United States
(12) Patent Application Publication
(10) Pub. No.: US 2017/0064504 A1
(43) Pub. Date: Mar. 2, 2017

(54) System and method for detecting a loss of portable property

(71) Applicant: Boban Jose, San Ramon, CA (US)

(72) Inventor: Boban Jose, San Ramon, CA (US)

(21) Appl. No.: 14/994,412

(22) Filed: Jan. 13, 2016

Related U.S. Application Data
(60) Provisional application No. 62/211,463, filed on Aug. 28, 2015.

(51) Int. Cl. H04W 4/02; H04B 17/318; H04L 12/26; H04B 17/23

(52) U.S. Cl. CPC H04W 4/023; H04B 17/23; H04B 17/318; H04L 43/16

(57) ABSTRACT

A method for detecting a loss of portable property includes receiving, by a receiver attached to a first portable item, a signal from at least one transmitter attached to a second portable item. The method includes detecting, by the receiver, a change in distance from the at least one transmitter. The method includes determining, by the receiver, using at least one motion sensor, which of the at least one transmitter and the receiver is in motion. The method includes selecting, by the receiver, an alarm condition, based on the determination.

### TECHNICAL FIELD

This invention relates to property security devices. More particularly, the present invention relates to a system to detect a loss of portable property.

### BACKGROUND ART

Travelers and commuters alike are well aware of the constant hazard presented by lost property. It takes no more than a momentary lapse in concentration to leave a briefcase behind on a train or in a taxi. Thieves can snatch purses and suitcases and melt into the crowd before they can be detected, or abscond with backpacks set beside unwitting students. These brief events can have painful consequences when the lost item includes money, passports, or other important materials. Vacations can be ruined by missing luggage, and careers can be thrown into jeopardy by the loss of sensitive documents. In many cases, if the owner of the lost item were aware just slightly sooner of the loss, the item might have been recovered.

In view of the above, there is a need for an efficient, discreet, and practical way to alert the owner of an item that the loss of the item is imminent.

### SUMMARY

In one aspect, a method for detecting a loss of portable property includes receiving, by a receiver attached to a first portable item, a signal from at least one transmitter attached to a second portable item. The method includes detecting, by the receiver, a change in distance from the at least one transmitter. The method includes determining, by the receiver, using at least one motion sensor, which of the at least one transmitter and the receiver is in motion. The method includes selecting, by the receiver, an alarm condition, based on the determination.

In a related embodiment, the receiver is a transceiver, and receiving further includes pairing with the at least one transmitter. In another related embodiment, detecting further includes detecting, by the receiver, a change in signal strength in the signal. In an additional embodiment, detecting further involves maintaining, by the receiver, a number that represents a threshold amount for the signal strength and determining that the signal has dropped below the threshold amount. In still another embodiment, the threshold is based on the probable distance that the at least one transmitter has reached from the receiver when the signal strength drops to the threshold amount. In yet another embodiment, determining that the signal has dropped below the threshold amount involves determining, by the receiver, the signal strength at a moment of pairing and setting, by the receiver, the threshold to a predetermined fraction of that signal strength. In a further embodiment detecting also includes detecting a change in distance from a first transmitter of the at least one transmitter and detecting that signal strength from a second transmitter of the at least one transmitter is above a threshold amount. In a further embodiment still, detecting involves detecting a change in distance from a first transmitter of the at least one transmitter and detecting that signal strength from a second transmitter of the at least one transmitter is below a threshold amount.

In another related embodiment, determining further includes determining, using a motion sensor incorporated in the receiver, that the receiver is moving. In a further embodiment, determining also includes determining, using a motion sensor incorporated in the receiver, that the receiver is not moving. In a further embodiment still, determining also includes receiving, by the receiver, from the at least one transmitter, an indication that the at least one transmitter is moving. In an additional embodiment, determining further includes receiving, by the receiver, from the at least one transmitter, an indication that the at least one transmitter is not moving.

In an additional embodiment, selecting further involves determining, by the receiver, that no user command to uncouple from the at least one transmitter has been received. In another embodiment, selecting also involves determining that the change in distance is not temporary. An additional embodiment also involves alerting, by the receiver, a user based on the alarm condition. In a further embodiment alerting additionally involves transmitting, by the receiver, information concerning the alert condition to the transmitter. A related embodiment further includes alerting, by the at least one transmitter, the user based on the alert condition. An additional embodiment involves receiving, by the receiver, from the user, an instruction to cancel the alert and canceling, by the receiver, the alert.

In another aspect, a system for detecting a loss of portable property includes a first portable item. The system includes a second portable item. The system includes at least one transmitter attached to the second portable item, the at least one transmitter emitting a signal. The system includes a receiver attached to the first portable item, the receiver configured to receive a signal from at least one transmitter attached to a second portable item, to detect a change in distance from the at least one transmitter, to determine using at least one motion sensor, which of the at least one transmitter and the receiver is in motion, and to select an alarm condition, based on the determination.

Other aspects, embodiments and features of the disclosed system and method will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation at its initial drawing depiction. For purposes of clarity, not every component is labeled in every figure. Nor is every component of each embodiment of the system and method is shown where illustration is not necessary to allow those of ordinary skill in the art to understand the device and method.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1A is a block diagram depicting an example of an computing device as described herein;

FIG. 1B is a block diagram of a network-based platform, as disclosed herein;

FIG. 2A is a block diagram of an embodiment of the disclosed system;

FIG. 2B is a schematic diagram illustrating a portable item with an incorporated transmitter;

FIG. 3 is a flow diagram illustrating one embodiment of the disclosed method; and

FIG. 4 is a flow diagram illustrating embodiments of methods for detecting a change in distance between a receiver and at least one transmitter.

### DETAILED DESCRIPTION OF SPECIFIC EMBODIMENTS

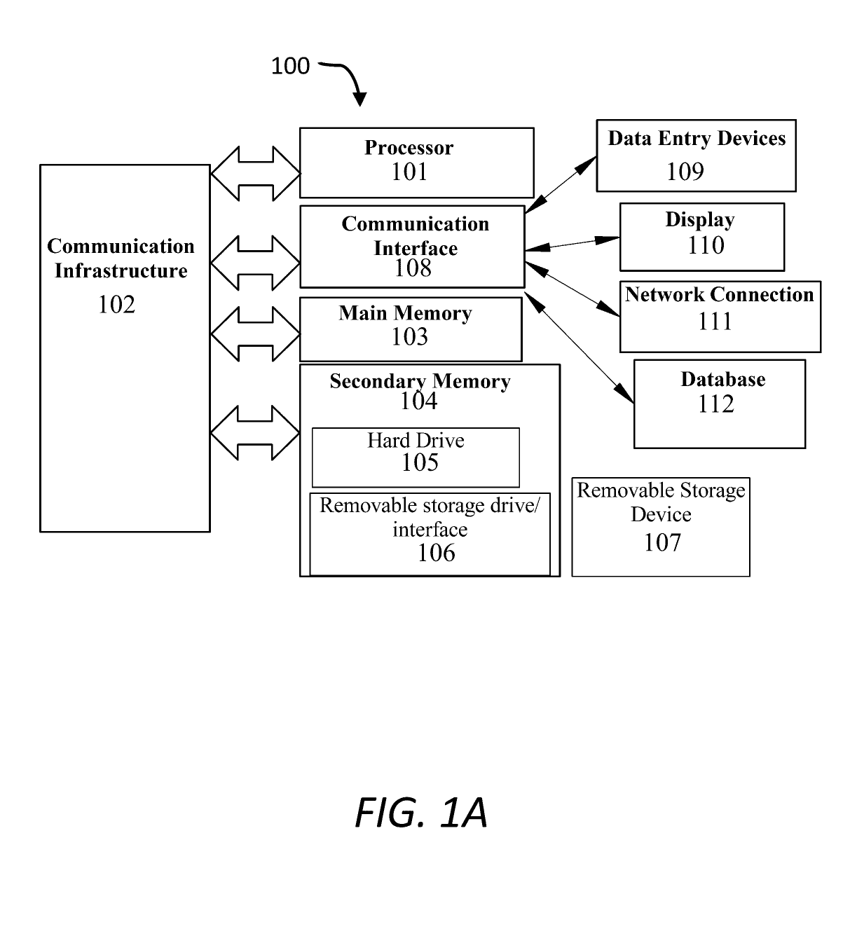

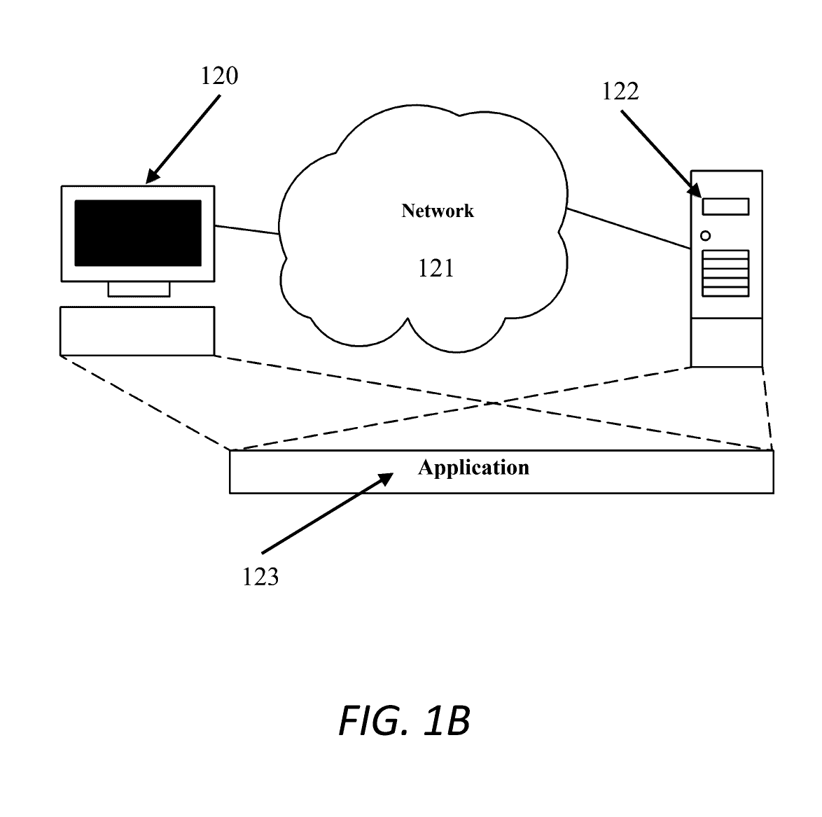

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers. In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The computing device 100 may employ one or more security measures to protect the computing device 100 or its data. For instance, the computing device 100 may protect data using a cryptographic system. In one embodiment, a cryptographic system is a system that converts data from a first form, known as “plaintext,” which is intelligible when viewed in its intended format, into a second form, known as “cyphertext,” which is not intelligible when viewed in the same way. The cyphertext is may be unintelligible in any format unless first converted back to plaintext. In one embodiment, the process of converting plaintext into cyphertext is known as “encryption.” The encryption process may involve the use of a datum, known as an “encryption key,” to alter the plaintext. The cryptographic system may also convert cyphertext back into plaintext, which is a process known as “decryption.” The decryption process may involve the use of a datum, known as a “decryption key,” to return the cyphertext to its original plaintext form. In embodiments of cryptographic systems that are “symmetric,” the decryption key is essentially the same as the encryption key: possession of either key makes it possible to deduce the other key quickly without further secret knowledge. The encryption and decryption keys in symmetric cryptographic systems may be kept secret, and shared only with persons or entities that the user of the cryptographic system wishes to be able to decrypt the cyphertext. One example of a symmetric cryptographic system is the Advanced Encryption Standard (“AES”), which arranges plaintext into matrices and then modifies the matrices through repeated permutations and arithmetic operations with an encryption key.

In embodiments of cryptographic systems that are “asymmetric,” either the encryption or decryption key cannot be readily deduced without additional secret knowledge, even given the possession of the corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which the encryption key involves the use of numbers that are products of very large prime numbers, but the decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an computing device as described above. The client device 120 connects via some form of network connection to a network 121, such as the Internet. The network 121 may be any arrangement that links together computing devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an computing device as described above, or a set of computing devices that communicate with each other and work in concert by local or network connections. Of course, practitioners of ordinary skill in the relevant art will recognize that a web application can, and typically does, run on several servers 122 and a vast and continuously changing population of client devices 120. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud.

Many computing devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause an computing device to operate as a web application client 120. Thus, as a general matter, web applications 123 require some computer program configuration of both the client device (or devices) 120 and the server 122. The computer program that comprises the web application component on either computing device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

The one or more client devices 120 and the one or more servers 122 may communicate using any protocol according to which data may be transmitted from the client 120 to the server 122 and vice versa. As a non-limiting example, the client 120 and server 122 may exchange data using the Internet protocol suite, which includes the transfer control protocol (TCP) and the Internet Protocol (IP), and is sometimes referred to as TCP/IP. In some embodiments, the client and server 122 encrypt data prior to exchanging the data, using a cryptographic system as described above. In one embodiment, the client 120 and server 122 exchange the data using public key cryptography; for instance, the client and the server 122 may each generate a public and private key, exchange public keys, and encrypt the data using each others' public keys while decrypting it using each others' private keys.

In some embodiments, the client 120 authenticates the server 122 or vice-versa using digital certificates. In one embodiment, a digital certificate is a file that conveys information and links the conveyed information to a “certificate authority” that is the issuer of a public key in a public key cryptographic system. The certificate in some embodiments contains data conveying the certificate authority's authorization for the recipient to perform a task. The authorization may be the authorization to access a given datum. The authorization may be the authorization to access a given process. In some embodiments, the certificate may identify the certificate authority.

The linking may be performed by the formation of a digital signature. In one embodiment, a digital signature is an encrypted a mathematical representation of a file using the private key of a public key cryptographic system. The signature may be verified by decrypting the encrypted mathematical representation using the corresponding public key and comparing the decrypted representation to a purported match that was not encrypted; if the signature protocol is well-designed and implemented correctly, this means the ability to create the digital signature is equivalent to possession of the private decryption key. Likewise, if the mathematical representation of the file is well-designed and implemented correctly, any alteration of the file will result in a mismatch with the digital signature; the mathematical representation may be produced using an alteration-sensitive, reliably reproducible algorithm, such as a hashing algorithm. A mathematical representation to which the signature may be compared may be included with the signature, for verification purposes; in other embodiments, the algorithm used to produce the mathematical representation is publically available, permitting the easy reproduction of the mathematical representation corresponding to any file. In some embodiments, a third party known as a certificate authority is available to verify that the possessor of the private key is a particular entity; thus, if the certificate authority may be trusted, and the private key has not been stolen, the ability of a entity to produce a digital signature confirms the identity of the entity, and links the file to the entity in a verifiable way. The digital signature may be incorporated in a digital certificate, which is a document authenticating the entity possessing the private key by authority of the issuing certificate authority, and signed with a digital signature created with that private key and a mathematical representation of the remainder of the certificate. In other embodiments, the digital signature is verified by comparing the digital signature to one known to have been created by the entity that purportedly signed the digital signature; for instance, if the public key that decrypts the known signature also decrypts the digital signature, the digital signature may be considered verified. The digital signature may also be used to verify that the file has not been altered since the formation of the digital signature.

The server 122 and client 120 may communicate using a security combining public key encryption, private key encryption, and digital certificates. For instance, the client 120 may authenticate the server 122 using a digital certificate provided by the server 122. The server 122 may authenticate the client 120 using a digital certificate provided by the client 120. After successful authentication, the device that received the digital certificate possesses a public key that corresponds to the private key of the device providing the digital certificate; the device that performed the authentication may then use the public key to convey a secret to the device that issued the certificate. The secret may be used as the basis to set up private key cryptographic communication between the client 120 and the server 122; for instance, the secret may be a private key for a private key cryptographic system. The secret may be a datum from which the private key may be derived. The client 120 and server 122 may then uses that private key cryptographic system to exchange information until the in which they are communicating ends. In some embodiments, this handshake and secure communication protocol is implemented using the secure sockets layer (SSL) protocol. In other embodiments, the protocol is implemented using the transport layer security (TLS) protocol. The server 122 and client 120 may communicate using hyper-text transfer protocol secure (HTTPS).

Embodiments of the disclosed system and methods provide a reliable, light-weight, and easily-concealed system to alert users to the imminent loss or theft of important items. The system may sound an alarm upon detecting an unexpected change in distance between the item in question and a device on the person of the user. Motion detectors and user settings can combine to avoid the inconvenience of false alarms.

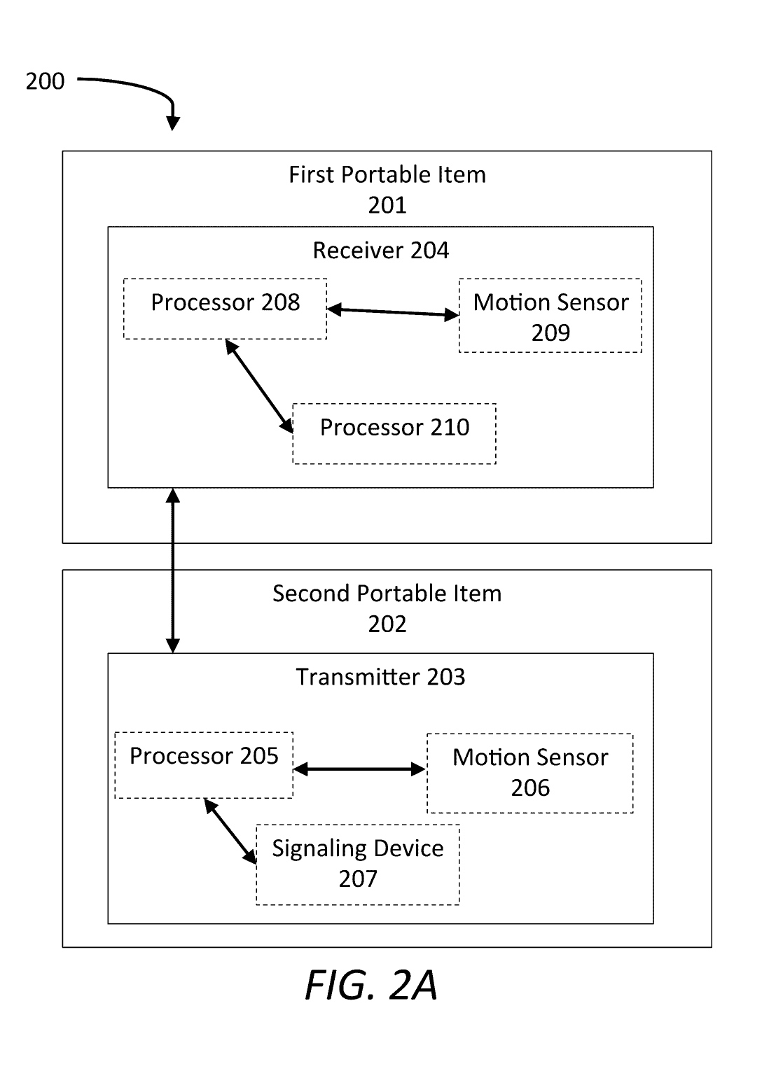

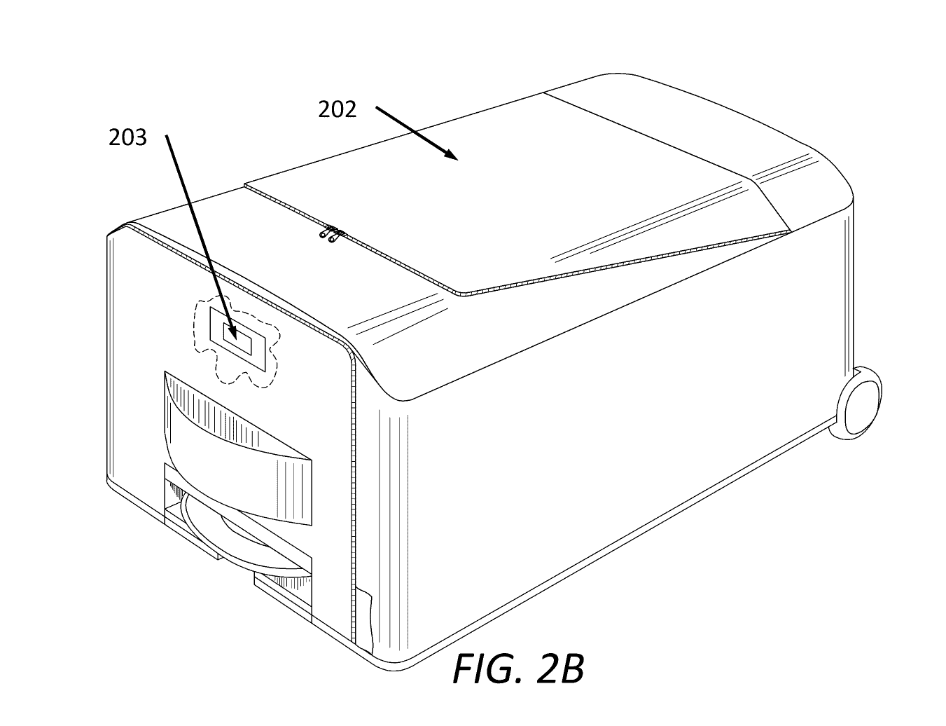

FIG. 2A illustrates an embodiment of a system 200 for detecting a loss of portable property. As an overview, the system 200 includes first portable item 201. The system 200 includes a second portable item 202. The system 200 includes at least one transmitter 203. The system 200 includes a receiver 204.

Referring to FIG. 2A in further detail, the system 200 includes a first portable item 201. In some embodiments, the first portable item 201 is an object that can be moved about by or on a person. The first portable item 201 may include a bag. The first portable item 201 may include an article of clothing. The first portable item 201 may include luggage, such as a suitcase, duffel bag, carry-on bag, or similar item. The first portable item 201 may include a briefcase, a backpack, a purse, a carryall, or any similar hand-held device. The first portable item 201 may include a portable electronic gadget such as a music player, tablet, smartphone, laptop, or wristwatch. The first portable item 201 may be a keychain, wallet or moneybelt. The owner of the first portable item 201 may be carrying it wheeling it, dragging it, or riding with it next to the owner on a seat or in a storage area. The owner of the first portable item 201 may be walking or riding on a bicycle, wheelchair, scooter, car, train, bus, airplane, or other vehicle for transporting people. The system 200 includes a second portable item 202. The second portable item 202 may be any object suitable for use as the first portable item 201.

The system 200 includes at least one transmitter 203. In some embodiments, the at least one transmitter 203 is attached to the second portable item 202. For the purposes of this description, the at least one transmitter 203 may be attached to the second portable item 202 if at least one of the at least one transmitter 203 is attached to the second portable item; for instance, a first transmitter of the at least one transmitter 203 may be attached to the second portable item, while a second transmitter of the at least one transmitter 203 may be attached to a different item that may or may not be portable. The at least one transmitter 203 may be adhered to the exterior of the second portable item 202. The at least one transmitter 203 may be concealed within the second portable item 202; for instance, as shown in FIG. 2B, where the second portable item 202 is an item of luggage, the at least one transmitter 203 may be embedded within the item of luggage, and concealed by the exterior cover of the item of luggage. The at least one transmitter 203 may be similarly embedded within another item, such as an item of clothing or a handbag. In other embodiments, the at least one transmitter 203 is a part of the second portable item 202. For example, where the second portable item 202 is an electronic device, such as a computing device, the at least one transmitter 203 may be one or more components of the computing device; the at least one transmitter 203 may be a device coupled to the second portable item 202, where the second portable item 202 is an electronic device. The at least one transmitter 203 may be attached to the second portable item 202 by any suitable means; for instance, where the second portable item 202 is a keychain, the at least one transmitter 203 may be strung on the keychain. The at least one transmitter 203 may have a housing enclosing the components of the at least one transmitter 203. The housing may be constructed of any suitable material or materials, including without limitation polymers such as plastic, metal, or natural products such as wood. The housing may have any form conducive to attachment of the at least one transmitter 203 to the second item of property 202. Where the second portable item 202 has a pocket or pouch, the at least one transmitter 203 may be attached to the portable item 202 by being slipped into that pocket or pouch.

In some embodiments, the at least one transmitter 203 includes a first transmitter and a second transmitter. For instance, the first transmitter may be attached to a portable item, as described above, while the second transmitter may be attached to an additional item. The additional item may be another portable item, as described above, such as an additional item of luggage or another mobile device. The additional item may be a household or office appliance or fixture; for instance, the additional item may be a thermostat, television, desktop computer, or other household or office device with a transceiver for local communication. The additional item may be part of an Internet of Things network, or may be implementing an Internet of Things protocol.

The at least one transmitter 203 may be an electronic device that emits a signal using electromagnetic radiation; the radiation used may have any frequency used for communication between devices. The signal may be a radio frequency signal such as those used for radio frequency communication. The signal may be a microwave signal. The signal may be an infrared signal. The signal may use visible light. The signal may be analog; for instance, the signal may be frequency modulated or amplitude modulated. The signal may be digital. In some embodiments, the signal is constantly emitted. In other embodiments, the signal is intermittently or periodically emitted. The at least one transmitter 203 may include an antenna (not shown).

In some embodiments, the at least one transmitter 203 is configured to transmit a simple signal without any modification; for instance, the at least one transmitter 203 may consist of hardwired circuitry that sends out a particular radio frequency signal without variation. In other embodiments, the at least one transmitter 203 has control circuitry. The control circuitry may include analog or digital circuit elements. In some embodiments, the at least one transmitter 203 includes a processor 205. The processor 205 may be a processor 101 as described above in connection with FIGS. 1A-1B. The processor 205 may be a microprocessor. The processor 205 may be programmable; for instance, the processor 205 may be coupled to memory, such as main memory 102 or secondary memory 103 as disclosed above in connection with FIGS. 1A-1B. The at least one transmitter 203 may be a transceiver, with the ability to both send and receive signals. In some embodiments, the at least one transmitter 203 is a “system on a chip,” combining several elements together in a small number of integrated circuits; for instance, the at least one transmitter 203 may have a single integrated circuit including a processor 205, transceiver, and memory. The at least one transmitter may be a computing device 100 as described above in reference to FIGS. 1A-1B; for instance, the at least one transmitter 203 may include a mobile device such as a smartphone or a special-purpose computing device created for use in the disclosed system and method. The at least one transmitter 203 may include a near-field communication device, such as those using the BLUETOOTH protocol promulgated by Bluetooth SIG, Inc. of Kirkland, Wash.

The at least one transmitter 203 may include at least one sensor. For instance, the at least one transmitter 203 may include at least one motion sensor 206. The at least one motion sensor may include any sensor or combination of sensors by means of which the at least one transmitter 203 may be able to detect its own motion. The at least one motion sensor 206 may include at least one accelerometer. In some embodiments, the at least one accelerometer includes two or more accelerometers; for example, the at least one accelerometer may include three accelerometers aligned to non-parallel axes (e.g., three mutually orthogonal accelerometers), coupled to the processor 205, enabling the processor 205 to determine the direction of acceleration of the at least one transmitter 203 in three dimensional space. The at least one motion sensor 206 may include at least one gyroscope. The at least one gyroscope may include two or more gyroscopes; for example, the at least one gyroscope may include three gyroscopes aligned to non-parallel axes (e.g., three mutually orthogonal gyroscopes), coupled to the processor 205, enabling the processor 205 to determine the direction of a change of pitch of the at least one transmitter 203 in three dimensional space. The at least one motion sensor 206 may include at least one magnetometer. The at least one magnetometer may include two or more magnetometers; for example, the at least one magnetometer may include three magnetometers aligned to non-parallel axes (e.g., three mutually orthogonal magnetometers), coupled to the processor 205, enabling the processor 205 to determine the a change of direction of the at least one transmitter 203, relative to a magnetic field such as the magnetic field of the Earth, in three dimensional space. In some embodiments, the at least one motion sensor 206 includes an inertial measurement unit (IMU) incorporating one or more accelerometers, gyroscopes, or magnetometers as described above; the IMU may also include a dedicated processor that interprets sensor input and renders it more easily usable for the processor 205.

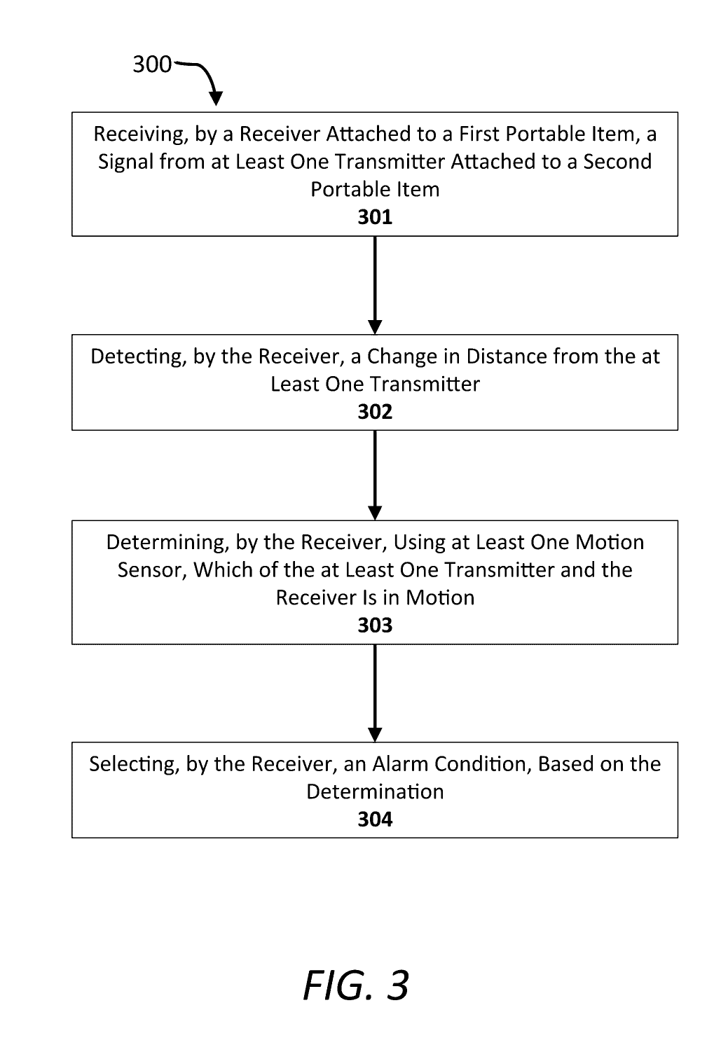

The at least one transmitter 203 may include at least one signaling device 207. The at least one signaling device 207 may be any device by means of which the at least one transmitter 203 can alert a user as set forth in further detail below in reference to FIG. 3. The at least one signaling device 207 may include an audio signaling device, such as a speaker, which emits an audible noise when activated. The at least one signaling device 207 may include a light-emitting device, such as a light, or a display 110 as described above in connection with FIGS. 1A-B. The at least one signaling device 207 may include a haptic device, such as a vibrator. The at least one signaling device 207 may combine a plurality of different signaling devices; for instance, the at least one signaling device 207 may include both an audio signaling device and a light-emitting device. Where the second portable item 202 is a mobile device, the at least one signaling device 207 may include one or more of the signaling devices incorporated in the mobile device 207, such as built-in speakers, vibrators, and the display.

The system 200 includes a receiver 204. In some embodiments, the receiver 204 is attached to the first portable item 201. The receiver 204 may be attached to the first portable item 201 by any means suitable for attaching the at least one transmitter 203 to the second portable item 202, as described above in reference to FIGS. 2A-B. The receiver 204 may have any housing suitable for use as the housing of the at least one at least one transmitter 203 as described above in reference to FIGS. 2A-B.

The receiver 204 may be a device that receives an electromagnetic signal; the receiver 204 may be capable of receiving the signal emitted by the at least one transmitter 203. In some embodiments, the receiver 204 is a transceiver; the receiver 204 may be any transceiver as described above in reference to FIG. 2A-B. The receiver 204 and at least one transmitter 203 may be configured to communicate according to any communication protocol that involves exchanging analog or digital information using electromagnetic signals. The receiver 204 and at least one transmitter 203 may exchange various kinds of data as set forth in further detail below. The receiver 204 may have a processor 208. The processor 208 may be any device suitable for use as a processor 205 as described above in reference to FIGS. 2A-B. In some embodiments, the receiver 204 has at least one motion sensor 209. The motion sensor 209 may be any device suitable for use as a motion sensor 206 as described above in connection with FIGS. 2A-B.

The receiver 204 may include at least one signaling device 210. The at least one signaling device 210 may be any device or devices useable as the at least one signaling device 207 of the at least one transmitter 203.

FIG. 3 illustrates some embodiments of a method 300 for detecting a loss of portable property. The method 300 includes receiving, by a receiver attached to a first portable item, a signal from at least one transmitter attached to a second portable item (301). The method 300 includes detecting, by the receiver, a change in distance from the at least one transmitter (302). The method 300 includes determining, by the receiver, using at least one motion sensor, which of the at least one transmitter and the receiver is in motion (303). The method 300 includes selecting, by the receiver, an alarm condition, based on the determination (304).

Referring to FIG. 3 in greater detail, and by reference to FIG. 2, the method 300 includes receiving, by a receiver attached to a first portable item, a signal from at least one transmitter attached to a second portable item (301). In some embodiments, the receiver 204 listens for a particular signal; for instance, the receiver 204 may be tuned to receive signals within a particular band. The receiver 204 may be programmed to ignore signals outside of a particular band. In some embodiments, the receiver 204 is configured to recognize a pattern identifying the at least one transmitter 203; for instance, where the signal is digital, the receiver may be configured to ignore the signal unless it contains a numerical code identifying the at least one transmitter 203 to the receiver 204.

In embodiments where the at least one transmitter 203 and receiver 204 are transceivers, the at least one transmitter 203 and receiver 204 may “pair”: that is, the receiver 204 may send the at least one transmitter 203 data identifying the receiver 204, and the at least one transmitter 203 may send the receiver 204 data identifying the at least one transmitter 203. In some embodiments, the receiver 204 is configured to pair with the at least one transmitter 203. The receiver 204 receive a user command instructing the receiver 204 to pair with the at least one transmitter 203; for instance, the receiver 204 may ask the user, via a user interface coupled to the receiver 204, whether the user wishes for the receiver 204 to pair with the at least one transmitter 203 that the receiver 204 has identified. In some embodiments, the receiver 204 displays an icon or other description identifying the at least one transmitter 203 to the user. The user may enter the instruction by selecting the icon, pressing a button indicating assent, or by similar means. In some embodiments, the receiver 204 stores the user instruction in memory accessible to the receiver 204; as a result, the receiver 204 may automatically pair with the at least one transmitter 203. For instance, the user may be prompted to instruct that the receiver 204 pair with the at least one transmitter 203 initially, and the user's instruction may then be stored in the receiver's memory to make pairing automatic upon detection on future occasions. The at least one transmitter 203 may likewise be configured to recognize and pair with the receiver 204, either automatically or based on a user instruction. In some embodiments, user enters the instruction on either the receiver 204 or the at least one transmitter 203, and the device the user did not enter the instruction on receives the instruction to pair from the device on which the instruction was entered. Persons skilled in the art will be aware of various protocols according to which two devices that communicate via electromagnetic radiation may pair.

The method 300 includes detecting, by the receiver, a change in distance from the at least one transmitter (302). In some embodiments, detecting the change in distance involves detecting, by the receiver 204, a change in signal strength in the signal. In some embodiments, the receiver 204 detects a change in signal strength by detecting that the signal has ceased. In other embodiments, the receiver 204 maintains a number, in the memory of the receiver 204, that represents a threshold amount for the signal strength; detecting the change in signal strength may involve determining that the signal has dropped below the threshold amount. The threshold may be based on the probable distance that the at least one transmitter 203 has reached from the receiver 204 when the signal strength drops to the threshold amount. In some embodiments, the receiver 204 determines the signal strength at the moment of pairing, and sets the threshold to a predetermined fraction of that signal strength.

In other embodiments, the receiver 204 detects the change in distance using data from a motion sensor. For instance, the receiver 204 may detect that the receiver 204 is in motion using the receiver's motion sensor 209. The at least one transmitter 203 may convey to the receiver 204 that it is not moving in the same direction, either because the at least one transmitter's motion sensor 206 has detected no movement, or because the at least one transmitter's motion sensor has detected that the at least one transmitter 203 is moving in a different direction from the receiver. In another embodiment, the receiver 204 determines that the receiver 204 is not moving, and receives data from the at least one transmitter 203 indicating that the at least one transmitter 203 is in motion.

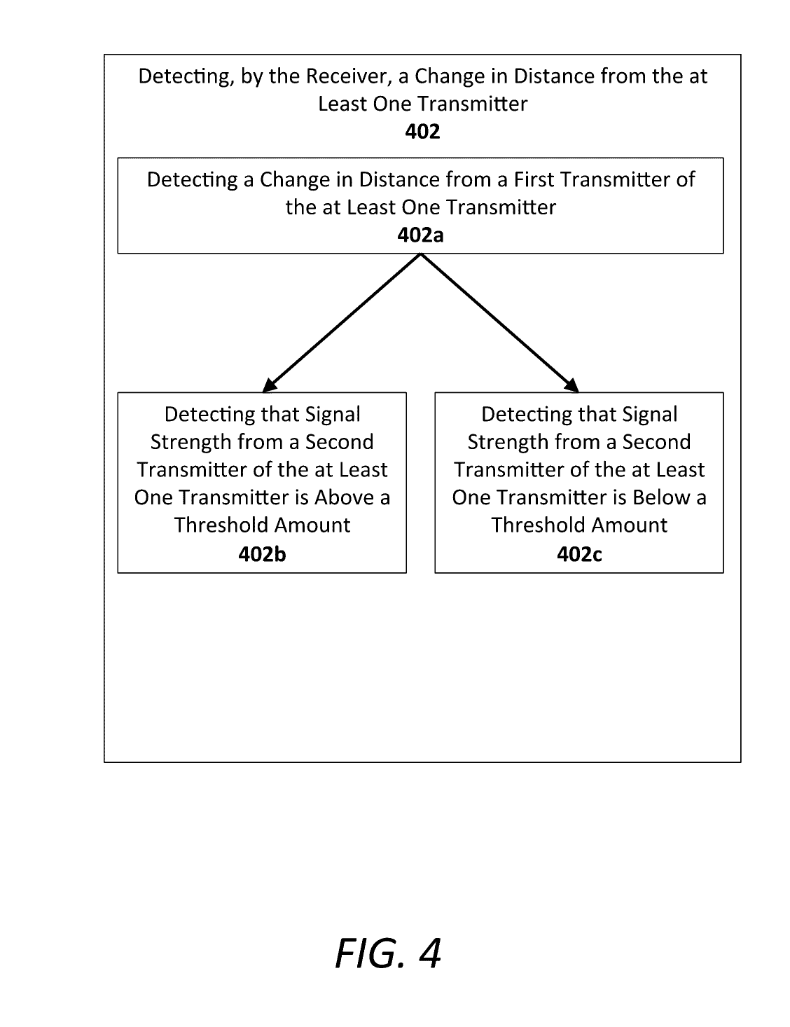

In some embodiments, detecting also involves detecting a change in distance, or a lack of change in distance, from an additional transmitter of the at least one transmitter 203. For instance, as shown in FIG. 4, in some embodiments, detecting 402 involves detecting a change in distance from a first transmitter of the at least one transmitter 402a and detecting that signal strength from a second transmitter of the at least one transmitter is above a threshold amount 402b. The threshold amount may be set similarly to the threshold amount described above regarding detection of signal strength with the transmitter. In some embodiments, the threshold is the minimum signal strength necessary to maintain a connection; that is, as long as a signal from the second transmitter was detectable, the receiver 204 may treat the signal as above the threshold.

As a non-limiting example, the receiver 204 may be attached to a luggage item, the first transmitter may be incorporated in a user's mobile device, and the second transmitter may be incorporated in a household appliance. Continuing the example, the receiver may detect that the user's mobile device is moving away from the receiver, while the household appliance remains at the same distance from the receiver as previously; this may correspond to an alarm state that triggers an alert, as described in further detail below, where the user has entered an instruction indicating that this should trigger an alert, for instance where the user plans to take the luggage item on a trip, and wishes to be warned that he or she is about to leave the luggage item at home. Alternatively, the same scenario may cause no alert to issue, because the user may not consider it problematic to have left the luggage item at home, and may have entered an instruction not to alert; either the instruction to alert or not to alert under these circumstances may be a default instruction followed by the receiver in the absence of user instruction. In other words, in some embodiments, the region (such as the user's house) within the signal-strength threshold is a “safe zone,” where detected separation between the receiver 204 and the first transmitter that might ordinarily match an alarm condition requiring notification of the user will instead match an alarm condition requiring no notification.

In another embodiment, detecting involves detecting a change in distance from a first transmitter of the at least one transmitter 402a and detecting that signal strength from a second transmitter of the at least one transmitter is below a threshold amount 402c. As a non-limiting example, if the receiver 204 is attached to an item of luggage, and detects a separation from a first transmitter that is a mobile phone, but detects a strong signal from a home appliance that is the second transmitter, the corresponding alarm state may require no user notification; on the other hand, if the same receiver 204 detects that the signal strength from the home appliance has fallen below a threshold, that may match an alarm state which assumes the luggage item is being taken from the user and the home, indicating possible theft and requiring an alert noticeable for many people to be activated.

Note that the receiver 204 may also be able to identify each transmitter; thus user or default instructions may be specific to the choice of first or second transmitter in the above scenarios, for instance alerting where the second transmitter is another item of luggage from which the receiver is being removed, but not where the second transmitter is incorporated in a household item. The user may therefore be able to enter instructions covering various distance changes involving various transmitters. Furthermore, persons of skill in the art will be aware that there may be third transmitters or more, the distance from each of which the receiver is able to determine, permitting the user to enter instructions dictating alarm conditions depending on various distance changes, or lack thereof, with various transmitters. It is also worth reiterating that where the receivers and transmitters are transceivers, the role of receiver or transmitter may be played by one or more devices simultaneously or depending on the circumstances; thus, both a device in an item of luggage and a user's mobile device may simultaneously detect that the user is leaving with one item of luggage and not another, and either or both may alert as a result.

The method 300 includes determining, by the receiver, using at least one motion sensor which of the at least one transmitter and the receiver is in motion (303). Determining which of the at least one transmitter 203 and the receiver 204 is in motion may include determining that both the receiver 204 and the at least one transmitter 203 are in motion. In some embodiments, the receiver 204 senses position data from the motion sensor 209 of the receiver 204. In other embodiments, the motion sensor 209 detects a change in position of the receiver 204; the motion sensor 209 may detect the change as described above in reference to FIG. 3. In other embodiments, the motion detector 209 indicates to the receiver 204 that the receiver 204 has not changed position. The receiver 204 may sense position data from the motion sensor 206 of the at least one transmitter 203. In other embodiments, the motion sensor 206 detects a change in position of the at least one transmitter 203; the motion sensor 206 may detect the change as described above in reference to FIG. 3. In other embodiments, the motion detector 206 indicates to the receiver 204 that the at least one transmitter 203 has not changed position. In some embodiments, the receiver 204 receives position data from both the motion sensor 209 of the receiver 204 and the motion sensor 206 of the at least one transmitter 203; the position data may indicate that the receiver 204, at least one transmitter 203, or both are stationary or moving, as described above.

The method 300 includes selecting, by the receiver, an alarm condition, based on the determination (304). In one embodiment, an alarm condition is a set of instructions for the receiver 204, at least one transmitter 203, or both to execute. The receiver may match the alarm condition to a set of parameters including, without limitation, changes in distance between the receiver 204 and the at least one transmitter 203, which of the receiver 204 and at least one transmitter 203 is in motion, user instructions in memory of the receiver 204 or the at least one transmitter 203, and default instructions stored in the memory of the receiver 204 or at least one transmitter 203 (e.g., instructions installed during manufacture or a software or firmware installation).

For instance, where the receiver senses a change in acceleration or direction in its motion sensor 209 and is being carried on the person of the user, the change in signal strength may indicate that the person has left the second piece of property 202 behind; in some embodiments, the receiver 204 is configured to interpret that as an intentional act, and may match those circumstances to an alarm condition indicating no further action is to be taken by the receiver 204; for instance, the receiver 204 may look up the alarm condition based on the existence of a change in distance, whether the receiver 204 is in motion, and whether the at least one transmitter 203 is in motion, in a look-up table, a hashtable, or a read-only memory. In other embodiments, the receiver may interpret the change in motion of the user carrying the receiver 204, coupled with the change in signal strength, as indicating that the user is about to lose the second portable item 202 by leaving it behind; this may match an alarm condition instructing the receiver 204 to alert the user by relatively unobtrusive means, such as a text message or chime on the user's mobile device, either sent to the mobile device where the receiver 204 is not the mobile device, or generated by the receiver 204 when the receiver is the user's mobile device. The user may have entered an instruction on the receiver 204 or at least one transmitter 203 indicating what the user wishes to have done in this situation; for example, the user may enter an instruction on the receiver 204 matching an alarm condition where no action should be taken on the detected change in distance and motion, because the user is about to leave a luggage item containing the at least one transmitter 203 at a baggage check. Similarly, where the user is concerned that he or she may misplace the item of portable property 202 to which the at least one transmitter 203 is attached, the user may enter an instruction matching the above set of circumstances to an alarm condition requiring an alert to be displayed or broadcast using the user's mobile device.

As a further illustrative example, where the receiver 204 is in a luggage item or similar portable item 201 and the at least one transmitter 203 is in the user's pocket, detected motion by the receiver 204 combined with a change in signal strength may indicate that the receiver is being stolen, along with the first item of property 201, which may match an alarm condition requiring the receiver 204 to transmit an alert concerning the apparent theft; the alarm condition may dictate that the alert transmitted by the receiver more obtrusive, as described in further detail below. In some embodiments, the motion sensor of the receiver 204 does not detect a change in acceleration, and detects a change in signal strength; where the receiver 204 is likely to be on the person of the user, for instance in a keychain, the receiver 204 may be configured to interpret the change in signal strength as a theft, matching an alarm condition that instructs the receiver 204, transmitter 203 or both to perform a highly noticeable alert action as described in further detail below. Where, alternatively, the at least one transmitter 203 is more likely to be on the person of the user, a lack of movement detected by the receiver 204 motion sensor 209 may indicate that the user is leaving the receiver 204 behind, once again perhaps matching an alarm condition requiring a subtler alert as describe below.

In some embodiments, selecting the alarm state involves detecting, using a motion sensor 206 incorporated in the at least one transmitter 203, motion consistent with an alarm state. The detection of motion may be used in any way described above for the detection of motion of the receiver 204. In addition, in some embodiments each of the motion detector 206 of the at least one transmitter 203 and the motion detector 209 of the receiver 204 detects a motion; for instance, where each motion detector can determine the direction of detected motion, and the at least one transmitter 203 accelerates in one direction while the receiver 204 accelerates in another direction, the receiver 204 may be configured to interpret the change in signal strength as indicating that the two portable items are being carried in opposite directions, which may be consistent with a theft; this may match an alarm state requiring an obtrusive alert. On the other hand, a user instruction may indicate that this pattern of motion matches a different alarm state; for instance, the user may intend to place the item containing the transmitter 203 on a conveyor belt and walk away in another direction with the receiver 204 on his or her person, and enter an instruction matching that scenario to an alarm condition in which no alert is emitted by either the receiver 204 or the at least one transmitter 203.

In some embodiments, motion detectors in both the at least one transmitter 203 and the receiver 204 detect changes of position; for instance, the user may be moving in one direction with one portable item, while another person or machine moves in another direction with the other portable item. The receiver 204 may interpret this data as a theft or lost property situation; for instance, where one item of property accelerates in one direction, and the other item accelerates in a different direction, the receiver 204 may treat this as consistent with a theft. Where both items accelerate in the same direction, the receiver 204 may interpret this as both items traveling on a vehicle together, for instance after the user has placed one item in a luggage compartment and gone to the user's seat.

As noted above, the alarm state may include as a parameter the signal strength from a second transmitter, such as a home appliance. For instance, where, as above, the region where the second transmitter's signal strength is above a certain threshold is a “safe zone,” the detected distance change and the determined motion may match a different alarm state than the one they would match outside the safe zone; as an example, where the receiver 204 is in an item of luggage and the first transmitter is on a phone that is leaving the safe zone while the receiver 204 remains in the safe zone, the alarm state that matches those parameters may not require any user notification, while the same separation outside the safe zone may correspond to an alarm state that notifies the user of the separation.

In some embodiments, selecting the alarm state involves determining that the change in distance is temporary. For instance, the receiver 204 may determine that the change in distance was temporary; the at least one transmitter 203 and receiver 204 may have separated and then come back together. In other embodiments, the receiver 204 determines that the change in distance is not sufficiently large to warrant an alert; for instance, the receiver 204 may have a threshold amount in memory indicating the minimum change in distance necessary to trigger an alert, so that merely putting a portable item at arm's length, or leaving it on a seat to get up and stretch, does not trigger an alert.

The user may also enter a command linking the parameters to an alarm state instructing the receiver 204 not to alert because the user is about to intentionally leave one portable item behind or in the possession of another person; an example is checking in luggage at an airport. For instance, the user may enter a command to uncouple the receiver 204 from the at least one transmitter 203. In some embodiments, the command to uncouple matches all possible parameters to alarm states requiring no notification; this may continue until the user enters a command for the receiver 204 and at least one transmitter to link together again. The user may enter a command to uncouple the at least one transmitter 203 and receiver 204 prior to intentionally giving the first portable item 201 or the second portable item 202 to another person or leaving it behind. The at least one transmitter 203 may likewise be configured to detect the user command and match any subsequent detected parameters to alarm states that instruct the at least one transmitter 203 not alert to a change in signal strength. The user may enter the command either on the receiver 204 or on the at least one transmitter 203; the user may also enter the command on a different computing device (not shown) that relays the command to the at least one transmitter 203, the receiver 204, or both.

In some embodiments, the receiver 204 or at least one transmitter 203 may automatically stop transmitting altogether. For instance, the at least one transmitter 203 or receiver 204 may detect, using the at least one motion sensor 206, 209, an acceleration consistent with an airplane taking off; the receiver 204 or at least one transmitter 203 may cease to transmit until reactivated by the user, either by direct manipulation or by receiving a renewed signal from the other device. In other embodiments, the receiver 204 or at least one transmitter 203 begins to transmit again upon sensing an acceleration consistent with the airplane landing.

In some embodiments, the receiver 204 alerts the user based on the alarm condition. In some embodiments, the receiver alerts the user by means of an audio signal. For instance, the receiver may emit a chime, bell, siren, or other audio alarm signal. The receiver 204 may produce an audio verbal message such as “your bag is being stolen” or “this is stolen property.” The receiver 204 may alert using a visible signal as well; for instance, where the at least one signaling device 210 includes a light, the receiver 204 may cause the light to shine or to flash. Where the receiver 204 has a display, the receiver 204 may display a message to the effect that the at least one transmitter 203 is moving away, relative to the receiver. Where the at least one signaling device 210 includes a vibrator, the receiver 204 may cause the vibrator to vibrate. The alert may include a combination of the above-described signals; for instance, the receiver 204 may emit an audio alarm while displaying a message, or may simultaneously flash lights, vibrate, and emit an audio alarm. In some embodiments, where the user has a computing device, such as a mobile device, which is neither the receiver 204 nor the at least one transmitter 203, the alert may be conveyed to the user by means of the computing device.

In some embodiments, the at least one transmitter 203 also alerts the user to the change in distance. The at least one transmitter 203 may produce any alert suitable for an alert issued by the receiver 204. In some embodiments, the alerts produced by the at least one transmitter 203 and receiver 204 are complementary, as set forth in further detail below. The alert or alerts may provide the user with the option to enter a command to the receiver 204, at least one transmitter 203, or both, in response to the alert; for instance, if one alert is conveyed to a mobile device on the person of the user, the alert may provide the user with a user interface permitting the user to cancel the alert, for instance because the property has been left behind intentionally, or to modify the alert. Options to modify the alert may include the ability to inform the receiver 204 or at least one transmitter 203 that the item of property has been lost, causing the receiver 204 or at least one transmitter 203 to respond in ways useful for recovering lost property. Options to modify the alert may include the ability to inform the system that the property has been stolen, causing the receiver 204 or at least one transmitter 203 to respond in ways useful for recovering stolen property.

The system 200 may produce different alerts depending on different apparent reasons for the change in distance. In particular, alarm states consistent with less urgent events, such as the user accidentally leaving an item of property behind may correspond to subtler or more discreet alerts tending to inform the user alone of the alarm state, while alarm states consistent with more urgent events, such as theft, may correspond to louder or more notorious alerts, intended to inform people more generally of the alarm condition. In the former case, for instance, the receiver 204, at least one transmitter 203, or both, may cause a message to display on the user's mobile device, so that receiving the alert is analogous to receiving a text message, phone call, or calendar reminder. In the latter case, the receiver 204, at least one transmitter 203, or both may produce loud noises, bright lights, verbal messages, or other outputs likely to be noticed by people generally, so that the user can more readily locate the item of property in question, and so that bystanders can aid in its recovery. Thus, as a further example, where the receiver 204 interprets the property has having been stolen, either due to a determination based on motion sensors as described above, due to different or similar changes in distance from additional transmitters as described above, or due to a user command indicating a misplaced portable item, the system 200 may produce outputs that aid in the recovery of a stolen item; such outputs may include either the at least one transmitter 203, the receiver 204, or both emitting an audio signal from within the apparently stolen property item, drawing attention to the item and making its concealment more difficult for a thief, boosting the signal strength of the receiver 204 or at least one transmitter 203, causing the receiver 203 and at least one transmitter 204 to repeatedly try to reconnect where the signal has been lost, indicating increases and decreases in signal strength to the user where the signal has been maintained or recovered, providing the user with the last known location of the property, and providing the user with a likely direction in which to search for the lost property, based on the data from the motion sensor (e.g., indicating an initial direction in which the apparently stolen property item was taken).

The alarm states may also instruct the receiver 204 or at least one transmitter 203 or both to perform additional actions to aid in recovery of lost property. For instance, where the system 200 interprets the property as having been left behind unintentionally, either due to a determination based on motion sensors as described above, to the detection of differing or similar changes in distance from additional transmitters as described above, or due to a user command indicating a misplaced portable item, the receiver 204, at least one transmitter 203, or both may produce outputs that aid in the recovery of a lost item; such outputs may include boosting the signal strength of the receiver 204 or at least one transmitter 203, causing the receiver 203 and at least one transmitter 204 to repeatedly try to reconnect where the signal has been lost, indicating increases and decreases in signal strength to the user where the signal has been maintained or recovered, providing the user with the last known location of the property, and providing the user with a likely direction in which to search for the lost property, based on the data from the motion sensor (e.g., if the user walked away from the item in a straight line, the system 200 may instruct the user to retrace his or her steps).

In some embodiments, the at least one transmitter 203 and receiver 204 produce complementary alerts. For instance, where the receiver 204 is incorporated in a mobile device on the person of the user, and the at least one transmitter is a special-purpose device embedded in a portable item 202, the receiver 204 may generate an alert using an audio signal transmitted via the speakers on the mobile device, and may display a verbal or graphical alert on the screen of the mobile device; at the same time, the at least one transmitter 203 may emit an audio alert, with the result that the user can track down the item 202 containing the at least one transmitter 203 more easily. In the same example, the at least one transmitter 203 may draw attention to a thief who has stolen the item 202, while the receiver 204 may inform the user that the item is missing even if the thief has succeeded in taking the item 202 out of earshot rapidly. Persons skilled in the art will appreciate that the at least one transmitter 203 and receiver 204 may similarly coordinate when the receiver 204 is a special-purpose device or the at least one transmitter 203 is a mobile device. The receiver 204 and at least one transmitter 203 may communicate with each other concerning the alert state; for instance, the receiver 204 may send the at least one transmitter 203 the alert so that the at least one transmitter will also alert the user. In other embodiments, the at least one transmitter 203 also detects the change in signal strength, triggering the at least one transmitter 203 to alert the user according to any method set forth above for the receiver 204 in reference to FIG. 3. As noted above, either the at least one transmitter 203, the receiver 204, or both may increase signal strength based on a detected change in distance or any other condition triggering an alert. As a non-limiting example, the at least one transmitter 203, receiver 204 or both may have the ability to transmit signals at multiple signal-strength levels, such as the class 1, class 2, and class 3 levels provided by the BLUETOOTH protocol described above; either the at least one transmitter 203, the receiver 204, or both may use a low-power signal in normal operation to conserve energy, and increase to a higher-power signal, with greater strength and range, upon an increase in distance or an alert state.

In some embodiments, the user enters an instruction on the receiver 204, at least one transmitter 203, or both cancelling the alert. In some embodiments, the receiver 204, at least one transmitter 203, or both send the user a message indicating the probable alert state based on the motion data, and the user may enter a command to confirm, cancel, or modify the alert state; for instance, the system 200 may convey a message to the user's mobile device indicating that the user appears to have placed the item in a luggage compartment, to which the user may reply “yes,” canceling the alert, or “no,” causing the user to be presented with a menu of alert options including options permitting classifying the item as stolen or lost.

The following non-limiting examples are provided for illustrative purposes only, to aid in understanding possible implementations of the method described in connection with FIG. 3. As one example, the second portable item 202 incorporating the at least one transmitter 203 may be a bag, suitcase, backpack, or item of luggage, and the first portable item 201 may be a mobile device such as a smartphone, with an application configuring the mobile device to act as the receiver 204; the at least one signaling device 210 in the receiver 204 may include a built-in speaker emitting ring tone, alert noise, or other sound, while the display of the mobile device may also convey a verbal or graphical message. Continuing the example, the receiver 204 may use a motion sensor built into the mobile device to determine whether the user is moving away from or toward the at least one transmitter 203 when the signal strength changes, as described above. Further continuing the example, the at least one transmitter 203 may be a special-purpose device with a small physical size readily concealed in the second portable item 202; the at least one transmitter 203 may have a speaker to emit an alarm as well. Thus, for example, in one embodiment, a mobile phone on the user may detect that the distance between the mobile phone and a luggage item containing the at least one transmitter is increasing; where the mobile phone is in motion and the luggage item is stationary, the mobile phone may alert, while if the luggage item is moving and the mobile phone is stationary, the mobile phone may not alert. As another example, the second portable item 202 attached to the at least one transmitter 203 may be a mobile device on the person of the user, while the receiver 204 may be a special-purpose device concealed in the first portable item 201, which may be a bag, item or luggage, or other object that might be prone to theft or loss. Thus, for example, in one embodiment, a device embedded in a luggage item may detect that the distance between device and a mobile phone on the person of a user is increasing; where the mobile phone is in motion and the luggage item is stationary, the device may not alert, while if the luggage item is moving and the mobile phone is stationary, the device may alert.

As an additional non-limiting example, both the at least one transmitter 203 and receiver 204 may be special-purpose devices; the first item of property 201 may be an item easily carried on a person, such as a key-chain, with the receiver 204 mounted on the key-chain in the form of a fob. The at least one transmitter 203 may alternatively be mounted on a key-chain while the receiver 204 is concealed in a readily-lost piece of property such as a luggage, backpack, or hand-bag.

Although the foregoing systems and methods have been described in some detail for purposes of clarity of understanding, it will be apparent that certain changes and modifications may be practiced within the scope of the appended claims.

What is claimed is:

1. A method for detecting a loss of portable property, the method comprising:
receiving, by a receiver attached to a first portable item, a signal from at least one transmitter attached to a second portable item;
detecting, by the receiver, a change in distance from the at least one transmitter;
determining, by the receiver, using at least one motion sensor, which of the at least one transmitter and the receiver is in motion; and
selecting, by the receiver, an alarm condition, based on the determination.

2. The method of claim 1, wherein detecting further comprises detecting, by the receiver, a change in signal strength in the signal.

3. The method of claim 2, wherein detecting further comprises:
maintaining, by the receiver, a number that represents a threshold amount for the signal strength; and
determining that the signal has dropped below the threshold amount.

4. The method of claim 3, wherein the threshold is based on the probable distance that the at least one transmitter has reached from the receiver when the signal strength drops to the threshold amount.

5. The method of claim 3 further comprising:
determining, by the receiver, the signal strength at a moment of pairing; and
setting, by the receiver, the threshold to a predetermined fraction of that signal strength.

6. The method of claim 1, wherein detecting further comprises:
detecting a change in distance from a first transmitter of the at least one transmitter; and
detecting that signal strength from a second transmitter of the at least one transmitter is above a threshold amount.

7. The method of claim 1, wherein detecting further comprises:
detecting a change in distance from a first transmitter of the at least one transmitter; and
detecting that signal strength from a second transmitter of the at least one transmitter is below a threshold amount.

8. The method of claim 1, wherein determining further comprises determining, using a motion sensor incorporated in the receiver, that the receiver is moving.

9. The method of claim 1, wherein determining further comprises determining, using a motion sensor incorporated in the receiver, that the receiver is not moving.

10. The method of claim 1 wherein determining further comprises:
receiving, by the receiver, from the at least one transmitter, an indication that the at least one transmitter is moving.

11. The method of claim 1 wherein determining further comprises:
receiving, by the receiver, from the at least one transmitter, an indication that the at least one transmitter is not moving.

12. The method of claim 1, wherein selecting further comprising determining, by the receiver, that no user command to uncouple from the at least one transmitter has been received.

13. The method of claim 1, wherein selecting further comprises determining that the change in distance is not temporary.

14. The method of claim 1, further comprising alerting, by the receiver, a user based on the alarm condition.

15. The method of claim 14, wherein alerting further comprises transmitting, by the receiver, information concerning the alert condition to the transmitter.

16. The method of claim 14 further comprising alerting, by the at least one transmitter, the user based on the alert condition.

17. The method of claim 14 further comprising:
receiving, by the receiver, from the user, an instruction to cancel the alert; and
canceling, by the receiver, the alert.

18. A system for detecting a loss of portable property, the system comprising:
a first portable item;
a second portable item;
at least one transmitter attached to the second portable item, the at least one transmitter emitting a signal;
a receiver attached to the first portable item, the receiver configured to receive a signal from at least one transmitter attached to a second portable item, to detect a change in distance from the at least one transmitter, to determine, using at least one motion sensor, which of the at least one transmitter and the receiver is in motion, and to select an alarm condition, based on the determination.
